(19) United States
(12) Patent Application Publication
(10) Pub. No.: US 2009/0298678 A1
(43) Pub. Date: Dec. 3, 2009

(54) STRENGTHENING IRON FISCHER-TROPSCH CATALYST BY CO-FEEDING IRON NITRATE AND PRECIPITATING AGENT OR SEPARATELY PRECIPITATING FROM FERROUS NITRATE AND FERRIC NITRATE SOLUTIONS

(75) Inventors: Belma DEMIREL, Longmont, CO (US); Jesse W. TAYLOR, Westminster, CO (US); Pandurang V. NIKRAD, Boulder, CO (US); Sara L. ROLFE, Loveland, CO (US); Dawid J. DUVENHAGE, Evergreen, CO (US); Harold A. WRIGHT, Longmont, CO (US)

Correspondence Address: CONLEY ROSE, P.C.;David A. Rose, P. O. BOX 3267, HOUSTON, TX, 77253-3267, US

(73) Assignee: RENTECH, INC., Los Angeles, CA (US)

(21) Appl. No.: 12/474,552

(22) Filed: May 29, 2009

Related U.S. Application Data
(60) Provisional application No. 61/058,126, filed on Jun. 2, 2008.

(51) Int. Cl. B01J 27/25

(52) U.S. Cl. 502/201

(57) ABSTRACT

A method of producing a catalyst precursor comprising iron phases by co-feeding a ferrous nitrate solution and a precipitation agent into a ferric nitrate solution to produce a precipitation solution having a desired ferrous:ferric nitrate ratio and from which catalyst precursor precipitates; co-feeding a ferric nitrate solution and a precipitation agent into a ferrous nitrate solution to produce a precipitation solution having a desired ferrous:ferric nitrate ratio and from which catalyst precursor precipitates; or precipitating a ferrous precipitate from a ferrous nitrate solution by contacting the ferrous nitrate solution with a first precipitation agent; precipitating a ferric precipitate from ferric nitrate solution by contacting the ferric nitrate solution with a second precipitation agent and combining the ferrous and ferric precipitates to form the catalyst precursor, wherein the ratio of ferrous:ferric precipitates is a desired ratio.

### CROSS-REFERENCE TO RELATED APPLICATIONS

This application claims the benefit under 35 U.S.C. § 119(e) of U.S. Provisional Patent Application No. 61/058,126 filed Jun. 2, 2008, the disclosure of which is hereby incorporated herein by reference in its entirety.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to iron Fischer-Tropsch catalysts. More particularly, the present invention relates to a method for precipitating iron from nitrate solutions to produce Fischer-Tropsch synthesis catalyst, and the catalyst produced thereby. Still more specifically, the present invention relates to a method of producing a Fischer-Tropsch catalyst by (1) co-feeding ferrous nitrate solution and precipitating agent into a solution of ferric nitrate whereby iron phases are precipitated; (2) co-feeding ferric nitrate solution and precipitating agent into a solution of ferrous nitrate whereby iron phases are precipitated; or (3) precipitating iron phases from ferrous nitrate solution and ferric nitrate solution separately using precipitating agent, and combining the precipitates formed.

2. Background of the Invention

The Fischer-Tropsch (FT) technology is used to convert a mixture of hydrogen and carbon monoxide (synthesis gas or syngas) to valuable hydrocarbon products. Often, the process utilizes a slurry bubble column reactor (SBCR). The technology of converting synthesis gas originating from natural gas into valuable primarily liquid hydrocarbon products is referred to as Gas To Liquids (GTL) technology. When coal is the raw material for the syngas, the technology is commonly referred to as Coal-To-Liquids (CTL). The FT technology is one of several conversion techniques included in the broader GTL/CTL technology.

One of the primary difficulties encountered in using iron-based catalysts for carrying out the FT reaction in a slurry bubble column reactor (SBCR) is the breakdown of the initial catalyst particles into very small particles, i.e. less than 5 microns in size. Although the small particle size is advantageous for increasing surface area and reaction rate of the catalyst, the problem lies in separating the small catalyst particles from the wax slurry medium. Separating the catalyst particles from the wax is desired since the iron catalyst when operated under the most profitable conditions wherein wax is produced utilizes removal of the wax from the reactor to maintain a constant height of slurry in the reactor.

It is impossible to determine the actual attrition resistance that is sufficient without knowing the type of reactor system, the type of wax/catalyst separation system and the system operating conditions.

Heretofore, attempts at developing strengthened iron-based catalysts have focused on producing the strongest possible catalysts, regardless of the actual strength sufficient for a particular system. Such approaches sacrifice activity and selectivity for catalyst strength which may exceed that which is sufficient. Most of the prior art has focused on attempting to maximize strength of the catalyst without due regard for the negative impact of high levels of strengthener, e.g. silica, on activity and selectivity. Further, tests for catalyst strength have been carried out ex-situ, i.e. outside the SBCRs. Many of the tests have been conducted in a stirred tank reactor (autoclave) which subjects the catalyst to severe shearing forces not typically encountered in slurry bubble column reactors.

Improved catalyst strength can be achieved by depositing the iron on a refractory support such as silica, alumina or magnesia or by adding a structural promoter to the baseline catalyst. The challenge is to strengthen the catalyst without appreciably compromising the activity and selectivity of the catalyst.

The inventors have reported, in U.S. patent application Ser. No. 12/198,459 filed Aug. 26, 2008 and entitled, “Strengthened Iron Catalyst for Slurry Reactors,” that strengthening of FT iron catalyst can be attained by precipitating iron phases from a mixture comprising ferrous and ferric nitrate. Mixing ferrous nitrate and ferric nitrate and maintaining the mixture at a desired ratio of ferric to ferrous iron is, however, time-consuming.

Accordingly, there is a need for a method of precipitating iron phases from ferrous nitrate and ferric nitrate at a desired ferrous iron to ferric iron ratio. A method of precipitating iron phases from ferrous nitrate and ferric nitrate without requiring maintenance of a ferrous/ferric nitrate solution comprising a desired ratio of ferric nitrate and ferrous nitrate may desirably enable more consistent iron-catalyst formation and/or a decrease in the time and/or cost of catalyst formation.

### SUMMARY

Herein disclosed is a method of producing a catalyst precursor comprising iron phases, the method comprising: (a) co-feeding a ferrous nitrate solution and a precipitation agent into a ferric nitrate solution to produce a precipitation solution from which catalyst precursor precipitates, wherein the ratio of ferrous nitrate solution to ferric nitrate solution in the precipitation solution is a desired ratio; (b) co-feeding a ferric nitrate solution and a precipitation agent into a ferrous nitrate solution to produce a precipitation solution from which catalyst precursor precipitates, wherein the ratio of ferrous nitrate solution to ferric nitrate solution in the precipitation solution is a desired ratio; or (c) precipitating a ferrous precipitate from a ferrous nitrate solution by contacting the ferrous nitrate solution with a first precipitation agent; precipitating a ferric precipitate from ferric nitrate solution by contacting the ferric nitrate solution with a second precipitation agent; and combining the ferrous precipitate and the ferric precipitate to form the catalyst precursor, wherein the ratio of ferrous precipitate to ferric precipitate is a desired ratio; wherein the iron phases are chosen from iron carbonates, iron oxides, iron hydroxides or combinations thereof. In embodiments, the precipitation agent is selected from the group consisting of NH₄OH, (NH₄)₂CO₃, NH₄HCO₃, NaOH, Na₂CO₃, NaHCO₃, KOH, K₂CO₃, KHCO₃, and combinations thereof. The precipitation agent can comprise sodium carbonate. The precipitation agent can comprise ammonium hydroxide. In embodiments, the first precipitation agent and the second precipitation agent are the same. In embodiments, the ratio of ferrous nitrate solution to ferric nitrate solution is in the range of from about 1:2.3 to about 1:10. In embodiments, the ratio of ferrous nitrate solution to ferric nitrate solution is about 1:3. In embodiments, the ratio of ferrous nitrate solution to ferric nitrate solution is about 1:9.

The method can further comprise co-precipitating at least one other metal or metalloid from a nitrate solution. The at least one other metal or metalloid can be selected from the group consisting of magnesium, copper, aluminum, silicon, and combinations thereof. In embodiments, the ferrous nitrate solution, the ferric nitrate solution, the precipitation solution, or a combination thereof comprises at least one other metal or metalloid. In embodiments, (c) further comprises precipitating at least one other precipitate from an additional nitrate solution with a precipitation agent, and wherein combining the ferrous precipitate and the ferric precipitate to form the catalyst precursor further comprises combining the at least one other precipitate with the ferrous precipitate and the ferric precipitate. The additional nitrate solution can comprise a metal or metalloid selected from the group consisting of aluminum, silicon, magnesium, copper, and combinations thereof. The additional nitrate solution can comprise copper.

Also disclosed is a catalyst precursor produced according to the previously-described method.

Also disclosed is a method of producing a catalyst, the method comprising: obtaining a catalyst precursor according to the previously-described method; washing the catalyst precursor; and alkalizing the washed catalyst precursor with an alkaline material. The alkaline material can comprise potassium carbonate. In embodiments, the desired ratio of ferrous nitrate solution to ferric nitrate solution is in the range of from about 1:2.3 to about 1:10. In embodiments, the ratio of ferrous nitrate solution to ferric nitrate solution is about 1:3. In embodiments, the ratio of ferrous nitrate solution to ferric nitrate solution is about 1:9.

The method can further comprise drying the washed catalyst precursor to produce a dried catalyst. The method can further comprise co-precipitating at least one other metal or metalloid from a nitrate solution. The at least one other metal or metalloid can be selected from the group consisting of magnesium, copper, aluminum, silicon, and combinations thereof. In embodiments, the ferrous nitrate solution, the ferric nitrate solution, the precipitation solution, or a combination thereof comprises at least one other metal or metalloid. In embodiments, (c) further comprises precipitating at least one other precipitate from an additional nitrate solution with a precipitation agent, and wherein combining the ferrous precipitate and the ferric precipitate to form the catalyst precursor further comprises combining the at least one other precipitate with the ferrous precipitate and the ferric precipitate. In embodiments, the additional nitrate solution comprises a metal or metalloid selected from the group consisting of aluminum, silicon, magnesium, copper, and combinations thereof. The additional nitrate solution can comprise copper.

The method can further comprise contacting the washed catalyst precursor with a structural promoter to produce a promoted the catalyst. The method can further comprise promoting the dried catalyst by contacting the dried catalyst with a promoter to produce a promoted catalyst. The structural promoter can comprise liquid potassium silicate. The structural promoter can comprise tetraethyl ortho silicate, TEOS. The method can further comprise activating the catalyst. Also disclosed is a catalyst produced by the method. The catalyst can be produced utilizing a ratio of ferrous nitrate solution to ferric nitrate solution in the range of from about 1:2.3 to about of about 1:10. The catalyst can be produced utilizing a ratio of ferrous nitrate solution to ferric nitrate solution of about 1:3. Alternatively, the catalyst can be produced utilizing a ratio of ferrous nitrate solution to ferric nitrate solution of about 1:9.

The present invention comprises a combination of features and advantages which enable it to overcome various problems of prior devices. The various characteristics described above, as well as other features, will be readily apparent to those skilled in the art upon reading the following detailed description of the invention, and by referring to the accompanying drawings.

### BRIEF DESCRIPTION OF THE DRAWINGS

For a more detailed description of the present invention, reference will now be made to the accompanying drawings, wherein:

FIG. 1 a plot of percent change in particle size distribution (PSD) as a function of time in hours during chemical attrition testing of catalysts RT166-ISB, AR72-02B1 and AR52-08B2.

FIG. 2 is a plot of weight percent fines as a function of time on stream during air jet attrition resistance testing of catalysts RT166-ISB, AR75-01B1 and AR80-01B1 compared with AR52-02B1 and AR72-02B1.

FIG. 3 shows results of a FT conversion experiment for catalyst RT166-ISB, (co-feed precipitation, 90/10 Fe(III)/Fe(II) ratio) activated with syngas H₂/CO=0.7 at 270° C. and 30 psig for 24 hours.

FIG. 4 shows the results of a FT conversion experiment for catalyst AR52-09B1, activated with Syngas, H₂/CO=0.7 at 270° C. and 30 psig for 24 hours.

FIG. 5 shows results of a FT conversion experiment for catalyst AR52-09B1, activated with CO, at 270° C. and 30 psig for 24 hours.

FIG. 6 shows results of a FT conversion experiment for catalyst AR72-01B1, (90/10 Fe(III)/Fe(II) ratio) activated with CO, at 270° C. and 30 psig for 24 hours.

### NOTATION AND NOMENCLATURE

The term “precipitation solution” is used herein to refer to an iron nitrate solution comprising ferrous nitrate and ferric nitrate at a desired ratio of ferrous iron to ferric iron.

The abbreviation “FTS” stands for “Fischer-Tropsch Synthesis.”

“Raw” catalyst refers to a formed, dry catalyst after calcination.

The chain growth probability alpha is a parameter used to characterize the product spectrum produced in FT synthesis. The Fischer-Tropsch synthesis can be described as a polymerization reaction in which methyl species act as initiators for chain growth. Anderson-Schultz-Flory (ASF) product distribution shows that a polymerization-like process effectively describes the product distribution of the Fischer-Tropsch synthesis. Each carbon number surface species has a probability of continuing the chain growth or terminating the polymerization to produce product. The product spectrum may be characterized by the chain growth probability alpha.

NL/gFe/h is normal liters per gram iron per hour. NLPH is “normalized liters per hour.” Normal conditions of temperature and pressure are defined as 0° C. and 1 atm. Unless stated or obviously otherwise, percentages and ratios are based on weight.

### DETAILED DESCRIPTION

### I. Overview

Herein disclosed is a method that may speed catalyst manufacture at dissolution and/or precipitation steps, and/or increase reproducibility of catalyst manufacture. A method of producing an iron FT catalyst which incorporates the precipitated iron phases enables production of a catalyst that exhibits resistance against breakdown during FT reaction and maintains activity and selectivity toward high molecular weight hydrocarbons. The herein disclosed co-feed precipitation method enhances catalyst pore size and may thus help limit a deactivation by plugging of catalyst pores.

In an FT process, a gas stream comprising hydrogen and carbon monoxide is introduced into a Fischer-Tropsch reactor which typically employs a catalyst slurry. The catalyst can be an iron-based catalyst. The catalyst can be a precipitated iron catalyst. The catalyst can be a precipitated iron catalyst that is promoted with predetermined amounts of potassium and copper depending on the preselected probability of linear condensation polymerization and the molecular weight distribution sought.

Production of the iron FT catalyst can comprise addition of an acid solution to a base, addition of a base solution to an acid solution, or a combination thereof, whereby iron phases are precipitated. It has been discovered that a mixture of ferrous and ferric nitrate plays a key role in making desired iron-based FT catalysts. Mixing ferrous nitrate and ferrous nitrate and maintaining a stable mixture is a time-consuming process. Failure to maintain the desired ratio, however, leads to the inconsistent production of catalyst due to instability of the mixture of ferrous and ferric nitrates.

This disclosure provides methods of obtaining precipitated iron phases from a precipitation solution comprising a desired ratio of ferrous to ferric iron. This method can be used to more consistently and reproducibly produce iron FT catalyst. At a targeted ferrous/ferric nitrate ratio, the precipitation step of iron catalyst manufacturing can take a long time if ferrous/ferric nitrate solution is not stable. The ferrous/ferric nitrate ratio may keep changing after mixing if the Fe(II)/Fe(III) solution is not stable. This impedes the precipitation process. Implementation of the disclosed method may resolve some of these problems and provide a significant cost savings in terms of material, time and/or labor in the catalyst manufacturing process, and also enable production of a consistent catalyst in a shortened production time.

As mentioned above, mixing ferrous and ferric nitrate solution and stabilizing the solution before the precipitation step takes significant time and effort. Alternative routes are presented herein to overcome these problems. These routes comprise: (1) co-feeding ferrous nitrate and precipitation agent into ferric nitrate solution to produce precipitate; (2) co-feeding ferric nitrate and precipitation agent into ferrous nitrate solution to produce precipitate; and (3) precipitating ferrous nitrate and ferric nitrate separately using precipitation agent(s) and combining the precipitates thus obtained. Combination of the separate precipitates can be performed prior to or subsequent a washing/filtration step.

Catalyst precipitation can further comprise separate precipitation of copper and mixing of the copper precipitate with the iron precipitates of (1), (2), or (3).

The above-mentioned methods can improve the physical characteristics of the catalysts produced thereby and/or can result in decreased cost and/or time of catalyst manufacture.

### II. Method of Precipitating Iron Phases from a Precipitation Solution Comprising Ferrous Nitrate and Ferric Nitrate

Ferrous nitrate solution will be referred to at times as ferrous nitrate solution (1); ferric nitrate solution will be referred to at times as ferric nitrate solution (2); precipitation solution comprising ferrous nitrate and ferric nitrate will be referred to at times as precipitation solution (3).

According to this disclosure, catalyst precursor is produced by (a) co-feeding a ferrous nitrate solution and a precipitation agent into a ferric nitrate solution to produce a precipitation solution (3) from which catalyst precursor precipitates; (b) co-feeding a ferric nitrate solution and a precipitation agent into a ferrous nitrate solution to produce a precipitation solution (3) from which catalyst precursor precipitates; or (c) precipitating a ferrous precipitate from a ferrous nitrate solution with a first precipitation agent, precipitating a ferric precipitate from ferric nitrate solution with a second precipitation agent; and combining the ferrous precipitate and the ferric precipitate to form the catalyst precursor.

The precipitation agent(s) can comprise a base. The precipitation agent, the first precipitation agent, and/or the second precipitation agent can be selected from NH₄OH, (NH₄)₂CO₃, NH₄HCO₃, NaOH, Na₂CO₃, NaHCO₃, KOH, K₂CO₃, KHCO₃, or a combination thereof. In specific embodiments, the precipitation agent, the first precipitation agent, and/or the second precipitation agent comprises sodium carbonate. In embodiments, the base is ammonium hydroxide. In embodiments, the first precipitation agent and the second precipitation agent are or comprise the same base.

In a first embodiment, a ferrous nitrate solution and a precipitation agent are co-fed into a ferric nitrate solution to produce a precipitation solution (3) from which catalyst precursor is precipitated. The amount of ferrous nitrate added to the ferric nitrate solution is such that precipitation solution (3) comprises a desired weight ratio of ferrous nitrate to ferric nitrate. In embodiments, the desired weight ratio of ferrous iron to ferric iron is in the range of from about 1%:99%. In embodiments, the desired weight ratio of ferrous iron to ferric iron is in the range of from about 10%:90% to about 40%:60%. In embodiments, the desired weight ratio of ferrous iron to ferric iron is in the range of from about 10%:90%: to about 35%:65%. In specific embodiments, the desired weight ratio is about 25%:75%.

In embodiments, the desired weight ratio of ferrous nitrate solution to ferric nitrate solution is about 10%:90%. The temperature of the ferrous nitrate solution can be in the range of from about 25° C. to about 35° C. The temperature of the precipitation agent (e.g. base) can be ambient or room temperature. In embodiments, the precipitation agent (e.g. base) is added at a temperature of between about 30° C. and about 35° C. The ferric nitrate solution can be at a temperature of greater than about 65° C. or a temperature of greater than about 70° C. In embodiments, the ferric nitrate solution is at a temperature in the range of from about 35° C. to about 75° C. prior to addition of ferrous nitrate solution and precipitation agent thereto. In embodiments, the ferric nitrate solution has a temperature in the range of from about 65° C. to about 70° C. prior to addition of ferrous nitrate solution and precipitation agent thereto.

The amount of precipitation agent can be such that the pH of the precipitation solution (3) reaches a pH value in the range of from about 7.0 to about 7.5; in embodiments, the amount of precipitation agent is such that the pH of the precipitation solution (3) reaches a value of about 7.4. At this point, metals precipitate from the precipitation solution (3) as oxides, hydroxides, carbonates, or a combination thereof. In embodiments, the mixture is subsequently cooled (e.g., to about 80° F./26.6° C.). In embodiments, the final pH is adjusted. The final pH can be adjusted to a pH value in the range of from about 7.0 to about 7.5; in embodiments, the final pH is adjusted to a pH value of about 7.2.

In a second embodiment, a ferric nitrate solution and a precipitation agent are co-fed into a ferrous nitrate solution to produce a precipitation solution (3) from which catalyst precursor is precipitated. The amount of ferric nitrate added to the ferrous nitrate solution is such that precipitation solution (3) comprises a desired weight ratio of ferrous nitrate to ferric nitrate. In embodiments, the desired weight ratio of ferrous iron to ferric iron is in the range of from about 1%:99%. In embodiments, the desired weight ratio of ferrous iron to ferric iron (or the desired weight ratio of ferrous nitrate solution to ferric nitrate solution) is in the range of about 10%:90% to about 40%:60%. In embodiments, the desired weight ratio of ferrous iron to ferric iron (or the desired weight ratio of ferrous nitrate solution to ferric nitrate solution) is in the range of from about 10%:90%: to about 35%:65%. In embodiments, the desired weight ratio of ferrous iron to ferric iron (or the desired weight ratio of ferrous nitrate solution to ferric nitrate solution) is about 25%:75%. In embodiments, the desired weight ratio of ferrous nitrate solution to ferric nitrate solution is about 10%:90%.

The temperature of the ferric nitrate solution can be in the range of from about 65° C. to about 70° C. In embodiments, the ferric nitrate solution is at a temperature of greater than about 70° C. The temperature of the precipitation agent (e.g. base) can be ambient temperature. In embodiments, the precipitation agent (e.g. base) is added at a temperature in the range of from about 30° C. to about 35° C. In applications, the ferrous nitrate solution has a temperature in the range of from about 25° C. to about 35° C. prior to addition of ferric nitrate solution and precipitation agent thereto.

As with the first embodiment, the amount of precipitation agent can be such that the pH of the precipitation solution (3) reaches a pH value in the range of from about 7.0 to about 7.5. In embodiments, the amount of precipitation agent is such that the pH of the precipitation solution (3) has a value of about 7.4. Following combination, metals precipitate out of precipitation solution (3). The metals can precipitate as oxides, hydroxides, carbonates, or a combination thereof. The mixture can subsequently be cooled (e.g., to about 80° F.). The final pH can be adjusted. In embodiments, the final pH is adjusted to a pH value in the range of from about 7.0 to about 7.5. In embodiments, the final pH is adjusted to a pH value of about 7.2.

In a third embodiment, the method of producing catalyst precursor comprising iron phases comprises forming a ferrous precipitate by combining a first precipitation agent with a ferrous nitrate solution, forming a ferric precipitate by combining a second precipitation agent with a ferric nitrate solution; and combining the ferrous precipitate and the ferric precipitate at a desired weight ratio of ferrous iron to ferric iron to produce the catalyst precursor.

In embodiments, the desired weight ratio of ferrous iron to ferric iron (or ferrous precipitate solution to ferric precipitate solution) is in the range of from about 1%:99% to about 40%:60%. In embodiments, the desired weight ratio of ferrous iron to ferric iron (or ferrous precipitate solution to ferric precipitate solution) is in the range of from about 10%:90% to about 40%:60%. In embodiments, the desired weight ratio of ferrous iron to ferric iron (or ferrous precipitate solution to ferric precipitate solution) is in the range of from about 10%:90%: to about 35%:65%. In embodiments, the desired weight ratio of ferrous iron to ferric iron (or ferrous precipitate solution to ferric precipitate solution) is about 25%:75%. In embodiments, the desired weight ratio of ferrous iron to ferric iron (or ferrous precipitate solution to ferric precipitate solution) is about 10%:90%.

Forming ferrous precipitate comprises combining ferrous nitrate solution with a first precipitation agent to form a ferrous precipitation solution. The amount of first precipitation agent can be such that the pH of the ferrous precipitation solution is in the range of from about 7.0 to about 7.5, or a pH value of about 7.4. The temperature of the ferrous nitrate solution can be in the range of from about 25° C. to about 35° C., prior to combination of the first precipitation agent therewith. In embodiments, the temperature of the first precipitation agent (e.g. base) is about ambient or room temperature. In embodiments, the first precipitation agent (e.g. base) has a temperature in the range of from about 30° C. and about 35° C.

Forming ferric precipitate comprises combining ferric nitrate solution with a second precipitation agent to form a ferric precipitation solution. The first and second precipitation agents can be the same or different. The temperature of the ferric nitrate solution can be in the range of from about 65° C. to about 70° C., prior to combination of the (second) precipitation agent therewith. In embodiments, the temperature of the ferric nitrate solution is greater than about 70° C. prior to combination of (second) precipitation agent therewith. In embodiments, the temperature of the precipitation agent is ambient or room temperature. In embodiments, the (second) precipitation agent (e.g. base) has a temperature in the range of from about 25° C. to about 35° C.

### Additional Metals/Metalloids

In embodiments, as described in U.S. patent application Ser. No. 12/198,459 filed Aug. 26, 2008 and entitled, “Strengthened Iron Catalyst for Slurry Reactors,” the iron FT catalyst further comprises a structural support such as a binder co-precipitated with iron. The disclosure of U.S. patent application Ser. No. 12/198,459 is incorporated hereby herein for all purposes not inconsistent with this disclosure. The support material can serve to enhance (e.g. increase) the structural integrity of the catalyst. In embodiments, the iron catalyst of the present disclosure comprises co-precipitated material selected from iron, silica, magnesium, copper, aluminum, or combinations thereof.

The method of forming iron catalyst precursor can further comprise dissolving predetermined quantities of copper or at least one metalloid or metal other than iron in nitric acid to form a solution comprising cupric nitrate and/or other nitrates and precipitating a catalyst precursor comprising metal oxides by the addition of sufficient precipitating agent to the solution formed. In embodiments, the at least one metalloid or metal other than iron is dissolved in the ferric nitrate solution, the ferrous nitrate solution, the precipitation solution, or a combination thereof prior to the contacting of precipitation agent therewith. The catalyst precursor can thus further comprise oxides of copper, and other metal oxides, in addition to iron oxides.

In embodiments, the method of producing the catalyst further comprises co-precipitation of at least one structural promoter with the iron of the iron catalyst. In embodiments, the ferrous nitrate solution, the ferric nitrate solution, or both comprises at least one structural promoter. In embodiments, the catalyst precursor comprises more than about 50 wt % of oxides including iron oxides and other oxides. In embodiments, the metal of the mixed oxides is chosen from silicon, magnesium, aluminum, copper, iron, or combinations thereof. In embodiments, the catalyst comprises up to 50 wt % oxides selected from oxides of copper, magnesium, silicon, aluminum and combinations thereof.

In some embodiments, the catalyst comprises oxides of magnesium, copper, and/or aluminum in addition to iron oxides, and is formed by co-precipitation of iron with magnesium, copper, and/or aluminum from a nitrate solution or solutions thereof.

In some embodiments, the catalyst is formed by co-precipitation with magnesium. In embodiments, magnesium is co-precipitated from magnesium nitrate solution. In some embodiments, the iron catalyst is formed by co-precipitation with copper. In embodiments, copper is co-precipitated from copper nitrate solution. In embodiments, the iron catalyst is formed by co-precipitation with aluminum. In embodiments, aluminum is precipitated from aluminum nitrate solution. In some embodiments, the iron catalyst is formed by co-precipitation of aluminum oxides from aluminum nitrate solution. In embodiments, the iron catalyst is formed by co-precipitation of iron with magnesium, silica, aluminum, copper, or a combination thereof.

In embodiments, iron catalyst is formed by co-precipitation of iron, copper, magnesium and aluminum. In embodiments, the ratio of magnesium to aluminum atoms in the catalyst and/or in the precipitation mixture is in the range of from about 0.4 to about 0.6. In embodiments, the ratio of magnesium to aluminum in the catalyst and/or in the precipitation mixture is about 0.5.

As discussed hereinabove, the iron FT catalyst can comprise a structural promoter. In embodiments, the structural promoter comprises tetraethyl orthosilicate, TEOS. Catalyst comprising structural promoter of silica can be formed by co-precipitating the catalyst from a solution comprising TEOS structural promoter. For example, in embodiments, the ferrous nitrate solution, the ferric nitrate solution, or both comprises TEOS.

### 1. Preparing Ferrous Nitrate Solution (1)

According to literature, when iron is dissolved in nitric acid of specific gravity of 1.05, ferrous nitrate is produced, but with more concentrated acids, a mixture of ferrous and ferric nitrates is produced. Iron is combined with nitric acid to produce ferrous nitrate, Fe(NO₃)₂ according to the following equations:

Fe+2HNO₃Fe(NO₃)₂+H₂. (1)

4Fe+10HNO₃→4Fe(NO₃)₂+NH₄NO₃+3H₂O. (1b)

Ferrous nitrate is known to be very unstable and yellow oxides (Fe₂O₃) can be precipitated on exposure to air according to the following equation:

6Fe(NO₃)₂+5H₂O→3Fe₂O₃+2NO+10HNO₃. (2)

Ferrous oxidation and precipitation leads to the production of ferric hydroxide (Fe(OH)₃) according to the following equation:

3Fe(NO₃)₂+7H₂O→3Fe(OH)₃+5HNO₃+NO. (3)

With time, ferric hydroxide can be mineralized, and ferric iron oxide formed.

Ferrous iron normally can be oxidized to ferric iron in minutes; however, the time for this oxidation is dependent on pH, temperatures and the presence of other soluble ions. The lower the pH and temperature, the longer time it takes for the completion of the oxidation reaction. At pH of 7.0, oxidation of Fe²⁺ occurs in about 1 hour at 21° C. and 10 hours at 5° C. At pH of 6, it occurs in about 100 hours.

In order to stabilize ferrous nitrate solution, formation of stable ferrous nitrate solution can comprise dissolving iron in nitric acid having a first nitric acid weight percent, and maintaining the solution at a first temperature for a first period of time. The ferrous nitrate solution can be stirred during the first period of time. In embodiments, the first temperature is a temperature of from about 25° C. to about 35° C. In embodiments, the first temperature is a temperature in the range of from about 30° C. to about 35° C. In embodiments, the period of time is greater than about 30 minutes. In embodiments, the first period of time is greater than about 40 minutes. In embodiments, the period of time is greater than about 45 minutes. In embodiments, the nitric acid used to dissolve the iron for preparation of the stable ferrous nitrate solution has a first nitric acid weight percent in the range of from about 5 to about 10 weight percent; a weight percent in the range of from about 6 to about 9 weight percent; or a weight percent of about 6 weight percent.

To enhance reproducibility, acid addition can be performed at a temperature of greater than about 30° C. After the acid addition step, the solution can be stirred for at least 45 minutes prior to heating to allow a more complete dissociation of the iron metal.

In embodiments, stable ferrous nitrate solution is stable for a second time period. In embodiments, the second time period is at least one hour, at least two hours, or at least one day. In embodiments, stable ferrous nitrate solution is stable for at least two days. In embodiments, stable ferrous nitrate solution is stable for at least three days. In embodiments, the percent Fe²⁺ in the stable ferrous nitrate solution changes by less than about 1% over a period of about one day. In embodiments, the percent Fe²⁺ in the stable ferrous nitrate solution changes by less than about 2% over a period of about one day. In embodiments, the percent Fe²⁺ in the stable ferrous nitrate solution changes by less than about 2% over a period of about two days. In embodiments, the ferrous nitrate solution is filtered. In embodiments, the stable ferrous nitrate solution is covered during the first time period. A “stable” solution has a percent Fe²⁺ that changes by less than about a desired amount (e.g., less than 2 weight percent or less than about 1 weight percent) over a time period (e.g., a time period of at least one hour, two hours, one day, two days, or a range therebetween). The stability of a solution can be determined by the ratio (the amount) of Fe²⁺ in the solution.

### 2. Preparing Ferric Nitrate Solution (2)

With nitric acid of specific gravity at around 1.115, ferric nitrate alone, Fe(NO₃)₃, is produced, and ferric (Fe³⁺) nitrate is known to be quite stable. Ferric Nitrate is produced by the following reactions:

Fe+3HNO₃→Fe(NO₃)₃+1.5H₂, and (4)

2Fe+8 HNO₃→2Fe(NO₃)₃+2NO+4H₂O. (4b)

Preparing ferric acid solution can comprise dissolving iron in nitric acid having a second weight percent nitric acid. The solution produced can be maintained at a second temperature for a third period of time. In embodiments, the amount of nitric acid is such that the ferric nitrate solution has a specific gravity of about 1.115. Without wishing to be limited by theory, at this specific gravity, substantially all of the iron may be in the oxidized form. In embodiments, the second temperature is a temperature of at least about 70° C. In embodiments, the second temperature is a temperature of at least about 75° C. In embodiments, the second temperature is a temperature of about 70° C. In embodiments, forming a solution of ferric nitrate comprises heating the ferric nitrate solution to a temperature in the range of from about 35° C. to about 75° C. In embodiments, the third period of time is a time of greater than about 30 minutes. In embodiments, the third period of time is a time of greater than about 40 minutes. In embodiments, the third period of time is a time of greater than about 45 minutes. In embodiments, the nitric acid used for dissolution of iron in preparation of ferric nitrate solution has a weight percentage of nitric acid in the range of from about 10 to 20 weight percent. In embodiments, the nitric acid used for dissolution of iron in preparation of ferric nitrate solution has a weight percentage of nitric acid in the range of from about 12 to 18 weight percent. In embodiments, the nitric acid used for dissolution of iron in preparation of ferric nitrate solution has a weight percentage of nitric acid of about 13 weight percent. In embodiments, the nitric acid is about 17 weight percent nitric acid. In embodiments, the ferric nitrate solution is filtered. In embodiments, the ferric nitrate solution is covered during the third time period.

To enhance reproducibility, acid addition can be performed at a temperature of greater than about 30° C. After the acid addition step is complete, the solution can be stirred for at least 45 minutes prior to heating to allow a more complete dissociation of the iron metal.

In embodiments, forming a solution of ferric nitrate further comprises heating the ferric nitrate solution to a temperature in the range of from 35° C. to 75° C. In embodiments, forming a solution of ferric nitrate further comprises heating the ferric nitrate solution to a temperature of greater than about 70° C. In embodiments, forming a solution of ferric nitrate further comprises heating the ferric nitrate solution to a temperature of greater than about 75° C.

In embodiments, the ferrous nitrate solution, the ferric nitrate solution, or both are filtered prior to combining with precipitation agent(s) to produce catalyst precursor.

Although discussed with respect to the production of iron FT catalyst, the catalyst precursor disclosed herein may be used for purposes other than FT conversion, and discussion thereof is not meant to be limiting.

### III. Method of Making Iron FT Catalyst Utilizing Precipitated Iron Phases Produced by Co-Feeding

In embodiments, an iron FT catalyst is formed according to the description in U.S. Pat. No. 5,504,118 and/or U.S. patent application Ser. No. 12/189,424, with the catalyst precursor being formed as described in Section II of this disclosure. The catalyst can be made using elemental iron and optionally copper as starting materials. The disclosures of U.S. Pat. No. 5,504,118 and U.S. patent application Ser. No. 12/189,424 are hereby incorporated herein in their entirety for all purposes not inconsistent with this disclosure.

Following precipitation, the catalyst precursor can be washed using high quality water which is preferably free of chlorine. The washing can be performed according to any methods known in the art. In embodiments, the slurry is introduced, e.g. pumped, from the precipitation vessel into a holding tank. The holding tank can be located upstream of a filtration apparatus, e.g. a vacuum drum filter. The catalyst precursor may be allowed to settle in the holding tank and a clear layer of concentrated solution may form above the solids. This layer may be drawn off before the slurry is washed and filtered. A vacuum drum filter fitted with water spray bars may be used for washing the catalyst precursor and concentrating the slurry. The electrical conductivity of the filtrate can be monitored to ensure complete washing of the catalyst precursor has been effected. For example, the catalyst precursor can be washed until the electrical conductivity of the filtrate is about 40, about 30, or about 20 percent or less of the original electrical conductivity.

In embodiments, following washing, the precipitate (or washed precipitate) is alkalized. The precipitate can be alkalized by any means known in the art. For example, the addition of potassium carbonate can be used to alkalize the precipitate or washed precipitate. In embodiments, alkalization is performed prior to spray drying in order to adjust the Fe:K ratio to a desired value. In embodiments, alkalization is performed prior to spray drying in order to provide a desired Fe:K ratio. For example, in embodiments, following washing of catalyst precursor, potassium carbonate is added in an amount appropriate for the quantity of iron contained in the batch. Potassium is a promoter for chain growth and may also maintain the catalyst in iron carbide form. Adding more than appropriate amount of potassium may cause formation of more oxygenated products which may oxidize the catalyst, and is generally avoided. In embodiments, potassium carbonate is added to the slurry after washing is completed and prior to spray drying. Potassium carbonate can be dissolved in a small amount of water and this solution mixed thoroughly with the catalyst precursor slurry to uniformly distribute the potassium. In embodiments, the weight percent of solid catalyst material in the slurry at this point is in the range of from about 8 to about 12.

In embodiments, as described in U.S. patent application Ser. No. 12/198,459 filed Aug. 26, 2008 and entitled, “Strengthened Iron Catalyst for Slurry Reactors,” the iron FT catalyst further comprises a structural support such as a binder incorporated after precipitation of the catalyst precursor or a support material coprecipitated with iron. The support material may serve to increase the structural integrity of the catalyst. In embodiments, the iron catalyst of the present disclosure comprises coprecipitated material selected from iron, silica, magnesium, copper, aluminum, and combinations thereof. Alternatively, or additionally, potassium silicate binder, colloidal silica, and/or tetraethyl ortho silicate (TEOS) can be added to a precipitated catalyst to increase the strength thereof.

In embodiments, the structural promoter is added to a conventional precipitated catalyst subsequent precipitation of the catalyst precursor comprising iron hydroxides, iron oxides and/or iron carbonates. In embodiments, structural promoter is co-precipitated with the catalyst material as described in Section II hereinabove, and additional structural promoter (e.g. binder) is added following the precipitation of the catalyst material.

In embodiments structural promoter comprising silicon is added to a catalyst precipitate, the precipitate comprising iron phases. The iron phases can include iron hydroxides, iron carbonates, iron oxides, and combinations thereof. The structural promoter can comprise potassium silicate aqueous solution, which will be referred to herein as liquid potassium silicate. In embodiments, the liquid structural promoter comprises tetraethyl ortho silicate, TEOS, or potassium silicate and is added such that the catalyst has a silica content of from about 1 wt. % to about 2.2 wt. %.

As mentioned above, in embodiments, various amounts of liquid potassium silicate (K₂SiO₂) are added to a raw precipitated catalyst. In embodiments, precipitated iron catalyst is impregnated by mixing thoroughly with various amounts of aqueous potassium silicate. In embodiments, the precipitate is heated to 125° C. at the rate of 2° C./min, and held at this temperature for 12 h, and then ramped to 350° C. at the rate of 1°/min, and calcined at this temperature for 16 h prior to impregnation with aqueous potassium silicate solution. In other embodiments, liquid potassium silicate is added to iron precipitate prior to spray drying of the impregnated precipitate. The iron catalyst can comprise SiO₂ concentrations in the range of from about 1.0 wt % to about 2.2 wt %. The potassium silicate solution can comprise SiO₂/K₂O in a desired ratio for the production of catalyst having the desired composition.

In embodiments, a precipitated iron catalyst is improved by adding a structural promoter to the catalyst precursor. In embodiments, the silicon-containing binder comprises potassium silicate, colloidal silica, TEOS, or a combination thereof. Without wishing to be limited by theory, adding the binder to the catalyst precursor may improve dispersion of the metals in the catalyst and/or minimize damage to particles by the addition of silica via incipient wetness method at a later stage.

In embodiments, the potassium carbonate and structural promoter are added simultaneously to precipitated catalyst precursor comprising iron, iron hydroxide, iron oxide, and/or iron carbonate. In embodiments, the structural promoter comprises silica in colloidal form. In embodiments, the silica is silica sol. In some embodiments, the silica sol is selected from TMA LUDOX, LUDOX, LUDOX AS-30 and polysilicic acid (available from Sigma Aldrich, St. Louis, Mo.).

In some embodiments, the at least one structural promoter comprises silica and the liquid structural promoter is added to the catalyst precursor (precipitated catalyst material) following the addition of potassium carbonate promoter. In embodiments, structural promoter (potassium silicate or TEOS; about 1 wt % to 3 wt %) is added to the precipitate comprising mixed metal oxides, hydroxides, and/or carbonates.

A spray dryer can be used to remove most of the water from the precipitated catalyst precursor and at the same time to produce roughly spherical precipitated catalyst particles having diameters in the range of 40 to 100 microns, prior to the addition of structural promoter comprising silicate via incipient wetness technique. In embodiments, a structural promoter is added to the catalyst precursor to yield a promoted mixture prior to drying as described above.

The catalyst can be heated in air (for example, to about 600° F.) to remove residual moisture and to stabilize the precipitated catalyst. In embodiments, this step is carried out in a fluidized bed which is heated electrically.

Following drying, the dried precipitated catalyst precursor can be calcined. In embodiments, calcination is carried out at a temperature in the range of from about 250° C. to about 450° C. In some embodiments, calcination is carried out at a temperature in the range of from about 300° C. to about 400° C. In some embodiments, calcination is performed at a temperature of about 350° C.

In embodiments, silicate structural binder is added to a calcined precipitated catalyst.

The iron catalyst can be activated prior to use in an FT process, as known to those of skill in the art. In certain embodiments, the iron catalyst is activated in situ. Many different activating procedures for promoted iron Fischer-Tropsch catalysts have been described in the literature. For example, one of the most definitive studies on activating iron Fischer-Tropsch catalysts for use in fixed-bed reactors was published by Pichler and Merkel. (United States Department of Interior Bureau of Mines, Technical Paper 718, By H. Pichler and H. Merkel, Translated by Ruth Brinkley with Preface and Foreword by L. J. E. Hofer, United States Government Printing Office, Washington, D.C., 1949, Chemical and Thermomagnetic Studies on Iron Catalysts For Synthesis of Hydrocarbons). In this study, high activity of the catalyst was correlated with the presence of iron carbides after the activation procedure. An effective procedure used carbon monoxide at 325° C. at 0.1 atm pressure. The study also showed how the presence of copper and potassium in the catalyst affected activation of the catalyst.

In embodiments, the iron catalyst is pre-treated in hydrogen. In embodiments, the iron catalyst is pretreated with a gas comprising carbon monoxide. In embodiments, the iron catalyst is pre-treated in synthesis gas. In embodiments, pre-treatment occurs at preselected conditions of temperature and pressure. In embodiments, these pre-selected conditions of temperature encompass a temperature of from about 250° C. to about 300° C. In embodiments, these pre-selected conditions of pressure encompass a pressure of from about 5 atm. to about 10 atm.

In embodiments, as described in U.S. Pat. No. 5,504,118, the activity and selectivity of the iron catalyst is improved by subjecting the iron catalyst to a hydrogen-rich synthesis gas at elevated temperature and pressure. The reaction of carbiding of the iron catalyst precursor using a hydrogen-rich synthesis gas and the subsequent Fischer-Tropsch reaction both produce water. Without wishing to be limited by theory, it is believed that the presence of this water prevents over-carburization of the catalyst and thereby improves the activity and selectivity of the catalyst. (See “The Influence of Water and of Alkali Promoter on the Carbon Number Distribution of Fischer-Tropsch Products Formed over Iron Catalysts” by L. Konig et al., Ber. Bunsenges. Phys. Chem. 91, 116-121 (1987)-c VHC Verlagsgesellschaft mbH, D-6940 Weinheim, 1987.)

In embodiments, hydrogen-rich synthesis gas is used in lieu of an inert gas for maintaining the iron catalyst in suspension while the slurry is being heated to approximately 200° C. At this point, the synthesis gas is replaced by an inert gas (nitrogen or carbon dioxide) until the activation temperature has been attained at which time activation is carried out using synthesis gas.

It has been reported in U.S. Pat. No. 5,504,118 that the presence of a large amount (20%) by volume of nitrogen in the synthesis gas used for pretreatment of a precipitated catalyst had no detrimental effect on the activation procedure. In embodiments, activation of the iron catalyst occurs in the presence of about 20% nitrogen.

In embodiments, the initial load of iron catalyst in a commercial-scale slurry reactor comprising several thousand pounds of catalyst is pretreated in the full-scale slurry reactor. During operation, however, when only a few hundred pounds of catalyst are to be pretreated to replace a portion of the inventory in the reactor to maintain activity, a separate pretreatment reactor may be desirable. The pretreatment reactor may be similar in design to the large Fischer-Tropsch reactor, but much smaller. The batch of slurry containing the pretreated catalyst is pumped into the large reactor as known to those of skill in the art.

In some embodiments, small amounts of iron catalyst, i.e. up to 10% by weight of the total amount of catalyst in the F-T reactor, are activated in situ by adding raw catalyst directly to the reactor at operating conditions.

In embodiments, the iron catalyst is activated by contacting the catalyst with a mixture of gaseous hydrogen and carbon monoxide at a temperature of from about 250° C. to 300° C., for about 0.5 to 5 hours, with a water vapor partial pressure of about 1 psia, and a hydrogen to carbon monoxide mol (or volume) ratio of about 0.7 to 1.5, the activation being effective to increase the selectivity of the activated iron catalyst in the subsequent formation of liquid hydrocarbons in a Fischer-Tropsch reaction. In embodiments, the syngas for activation has a H₂:CO mol ratio of about 1.4. In embodiments, activation in syngas occurs for a time period up to 6 hours. In embodiments, the catalyst in wax or oil is first heated to 275° C. in H₂ and then syngas is fed for activation.

For example, the catalyst of this disclosure can be activated using a “typhoon” activation method. According to this method, in situ catalyst activation is performed by heating the catalyst to 275° C. in nitrogen, feeding syngas at a H₂:CO ratio of 1.4 once attaining a temperature of 275° C., activating at 275° C. under 140 psig pressure for 4-24 hours (depending on the space velocity).

In some embodiments, iron catalyst optionally comprising support material (e.g. MgAl₂O₄, MgAl₂O₄—SiO₂, Al₂O₃, SiO₂, SiO₂—Al₂O₃, etc.) in oil or wax is first heated to 200° C. in N₂, and then syngas is fed, and the temperature is ramped to a temperature in the range of about 285° C. to 300° C. In embodiments, the syngas used for activation has a H₂:CO ratio of about 0.7. In embodiments, the temperature is ramped from 200° C. to a temperature of from about 285° C. to about 300° C. at a ramp rate in the range of from 1° C./min to about 5° C./min.

In some embodiments, iron catalyst according to this disclosure is activated with 100% CO.

### IV. Iron FT Catalyst Formed by Co-feeding Iron Nitrate Solution and Precipitation Agent or Separate Precipitation from Ferrous Nitrate and Ferric Nitrate Solutions

In embodiments, depending on the preselected alpha, i.e., the polymerization probability desired, the precipitated iron catalyst has a weight ratio of potassium (e.g., as carbonate) to iron in the range of from about 0.005 and about 0.015, in the range of from 0.0075 to 0.0125, or about 0.010. Larger amounts of alkali metal promoter (e.g., potassium) cause the product distribution to shift toward the longer-chain molecules, while small amounts of alkali metal result in predominantly gaseous hydrocarbon product.

The weight ratio of copper to iron in the iron FT catalyst can be in the range of from about 0.005 and 0.050, in the range of from about 0.0075 and 0.0125, or about 0.010. Copper may serve as an induction promoter. In embodiments, the weight ratio of Cu:Fe is about 1:100.

As discussed in Section III hereinabove, the iron FT catalyst can further comprise structural promoter to significantly reduce the breakdown of the catalyst in a SBCR (slurry bubble column reactor). The structural promoter can comprise silica, and may enhance the structural integrity during activation and operation of the catalyst. In embodiments, the catalyst comprises a mass ratio of SiO₂:Fe of less than about 1:100 when the structural promoter comprises silica and less than about 8:100 when the structural promoter comprises silica sol.

In embodiments, the at least one structural promoter is chosen from oxides of metals and metalloids or combinations thereof. The structural promoter may be referred to as a binder, a support material, or a structural support.

Depending on the level of structural promoter comprising silicate and the preselected alpha, i.e. the polymerization probability desired, the weight ratio of K:Fe is from about 0.5:100 to about 6.5:100. In embodiments, the weight ratio of K:Fe is from about 0.5:100 to about 2:100. In some embodiments, the weight ratio of K:Fe is about 1:100.

In some embodiments wherein the structural promoter comprises silica sol, the weight ratio of iron to potassium is in the range of from about 100:1 to about 100:5. In some embodiments, the weight ratio of iron to potassium is in the range of from about 100:2 to about 100:6. In embodiments, the weight ratio of iron to potassium is in the range of from about 100:3 to about 100:5. In some embodiments, the weight ratio of iron to potassium is in the range of from about 100:4 to about 100:5. In embodiments, the weight ratio of iron to potassium is in the range of from about 100:2 to about 100:4. In embodiments, the weight ratio of iron to potassium about 100:3. In embodiments, the weight ratio of iron to potassium about 100:5.

In embodiments wherein the structural promoter comprises silica sol, the weight ratio of iron to copper is in the range of from about 100:1 to about 100:7. In embodiments, the weight ratio of iron to copper is in the range of from about 100:1 to about 100:5. In embodiments, the weight ratio of iron to copper is in the range of from about 100:2 to about 100:6. In embodiments, the weight ratio of iron to copper is in the range of from about 100:3 to about 100:5. In embodiments, the weight ratio of iron to copper in the range of from about 100:2 to about 100:4. In other specific embodiments, the weight ratio of iron to copper about 100:5. In yet other specific embodiments, the weight ratio of iron to copper is about 100:3.

Broadly, in embodiments, wherein the structural promoter is silica sol, the iron to SiO₂ weight ratio can be in the range of from about 100:1 to about 100:8; alternatively, in the range of from 100:1 to 100:7. In embodiments, wherein the structural promoter is silica, the iron to SiO₂ weight ratio can be in the range of from about 100:2 to about 100:6. In embodiments, the weight ratio of iron to silica is in the range of from about 100:3 to about 100:5. In embodiments, wherein the structural promoter is silica, the iron to SiO₂ weight ratio is about 100:5. In embodiments, wherein the structural promoter is silica, the iron to SiO₂ weight ratio can be in the range of from about 100:3 to about 100:7; alternatively, in the range of from about 100:4 to about 100:6.

In embodiments, the Fe:Cu:K:SiO₂ mass ratio is about 100:4:3:5.

During FT conversion, the percent by weight of the disclosed iron catalyst in the reactor slurry (for example, in a slurry bubble column reactor, or SBCR) is in the range of from 5 to 15 percent by weight of iron in the slurry, between 7.5 and 12.5 percent by weight, or about 10 percent by weight of the slurry.

### V. Properties of Catalyst

### Activity, Selectivity, CO Conversion, Yield and Alpha

In embodiments, the methods of producing iron-based catalysts yield catalysts for which the structural integrity of the catalyst is enhanced while maintaining substantial catalytic activity.

In embodiments, the CO conversion is maintained or increased by the method and catalyst disclosed herein. In embodiments, the catalyst of this disclosure is a high alpha catalyst having chain-growth characteristics substantially similar to the chain growth characteristics of a conventionally precipitated FT catalyst.

In embodiments, the FT catalyst of this disclosure produces a smaller quantity of fines than conventional FT catalysts during catalyst activation and/or FT reaction.

### VI. EXAMPLES

### Example 1

### Co-Feed Experiments with Ammonium Hydroxide Precipitating Agent

A number of co-feed experiments were conducted; data for these experiments is presented in Table 1. All experiments were conducted with ammonium hydroxide as the precipitating agent. For some materials silica was added in the ratio of 100 Fe to either 5 SiO₂ or 2.5 SiO₂. For catalysts RT159-01, RT162-1S, and RT166-1S two separate iron nitrate solutions were prepared in a 90/10, Fe(III)/Fe(II), ratio. The Fe(III) and the ammonium hydroxide solution were placed in separate addition funnels and added with mechanical stirring to the dilute Fe(II) solution according to the second embodiment presented in Section II hereinabove. Catalyst RT160-01 was prepared in a similar manner, with exception that the Fe(II) and the ammonium hydroxide solution were placed in separate addition funnels and added with mechanical stirring to the dilute Fe(III) solution, according to the first embodiment presented in Section II hereinabove. The separate precipitation catalysts, RT167-01 and RT167-1S were prepared according to the third embodiment presented in Section II hereinabove by separately precipitating an Fe(III) nitrate, an Fe(II) nitrate (90/10, Fe(III)/Fe(II)), and a copper nitrate. The slurries were then combined and mixed for 30 minutes followed by filtration, washing, promoter addition and spray drying.

TABLE 1
Co-Feed Experiments, calcined at 300° C., 16 hours, 30° C./minute ramp.

| | | | Hem. | | | | | |
|---|---|---|---|---|---|---|---|---|
| | | | Peak | Cryst. | Surface | Pore Vol., | Pore | Mag. |
| Cat # | Composition | Addition** | (XRD) | Size, nm | Area, m²/g | cc/g | Dia., Å | Susc. |
| Comparison | 100 Fe/1 Cu/1 K | NH₄OH→Fe(III)/Fe(II) | 560 | 27 | 56.0 | 0.2116 | 110 | 1233 |
| Catalyst | | | | | | | | |
| RT159-01B | 100 Fe/1 Cu/1 K | Fe(III) + NH₄OH→Fe(II) | 298 | — | 107.0 | 0.3696 | 97^{†} | ≧3822 |
| RT160-01B | 100 Fe/1 Cu/1 K | Fe(II) + NH₄OH→Fe(III) | 598 | 22 | 89.2 | 0.2113 | 57 | — |
| RT162-1SB | 100 Fe/4 Cu/3 K/5 SiO₂ | Fe(III) + NH₄OH→Fe(II) | 275 | — | 147.5 | 0.4738 | 80^{†} | — |
| RT166-1SB* | 100 Fe/4 Cu/3 K/5 SiO₂ | Fe(III) + NH₄OH→Fe(II) | 174 | — | 139.0 | 0.5422 | 78^{†} | — |
| RT163-01B | 100 Fe/1 Cu/1 K | Fe(III) + Fe(II) → NH₄OH | 154 | — | 124.2 | 0.3007 | 50 | ≧3902 |
| RT167-01B* | 100 Fe/1 Cu/1 K | Separate Precipitations | 349 | 19 | 83.1 | 0.2349 | 57 | — |
| RT167-1SB* | 100 Fe/1 Cu/1 K/2.5 SiO₂ | Separate Precipitations | 257 | 21 | 94.8 | 0.2558 | 57 | — |

*Quadruple batch,
**Co-feed additions, + indicates separate addition funnels added at the same time.
^{†}Indicates pore diameter peak was broader than normal.

Table 1 summarizes the results of the formation and characterization of the co-feed catalysts, along with non-co-feed conventional catalyst. These different preparation methods produce very different catalysts. When the Fe(III) and ammonium hydroxide were added to the Fe(II), very large pore volumes and large, broad pore diameters were produced. Addition of silica and increasing the copper and potassium did not seem to significantly alter these properties. The addition of an Fe(II) and ammonium hydroxide to an Fe(III) solution seems to produce essentially the same catalyst as adding the base to a mixture of the two iron species. Precipitation of the individual metal species again shows catalyst physical properties similar to the standard catalyst. This is probably dominated by the Fe(III) precipitate.

### Example 2

### Co-Feed Experiments with Silica Structural Promoter

Catalysts were prepared using the co-feed method. Data for these materials are shown in Table 2 along with the non-silica analogous material, RT159-01A and RT159-01B. The silica containing materials have the composition of 100Fe/4Cu/3K/5SiO₂ (Ludox), the non-silica containing material has the composition of 100Fe/1Cu/1K. For all materials the ratio of Fe(III) to Fe(II) in the nitrate solution was 90/10. For catalysts RT169 and RT170, the silica was added after precipitation, prior to pH adjustment.

For catalyst RT169 the Fe(III) and N OH were added to the Fe(II) solution, according to embodiment (2) described in Section II hereinabove. The pH was maintained at 5.0. After complete precipitation, the Ludox was added and the mixture was adjusted to a pH of 7.2 with NH₄OH.

Catalyst RT170 was prepared in a similar way, according to embodiment (2), with the Fe(III) and NH₄OH being added to the Fe(II) solution such that the pH was maintained at 7.2. Here again after complete precipitation, the Ludox was added to the precipitation mixture. Characterization of these catalysts is presented in Table 2. Comparison of catalysts RT169 and RT170 shows that the basic precipitation produces a catalyst with larger pore volumes and pore diameters. The effect of adding the silica to the precipitation mixture can be examined by comparing catalysts RT170 and RT162. The major difference is the pore volume, with the silica added after precipitation having a smaller pore volume.

### Example 3

### Chemical Attrition Tests

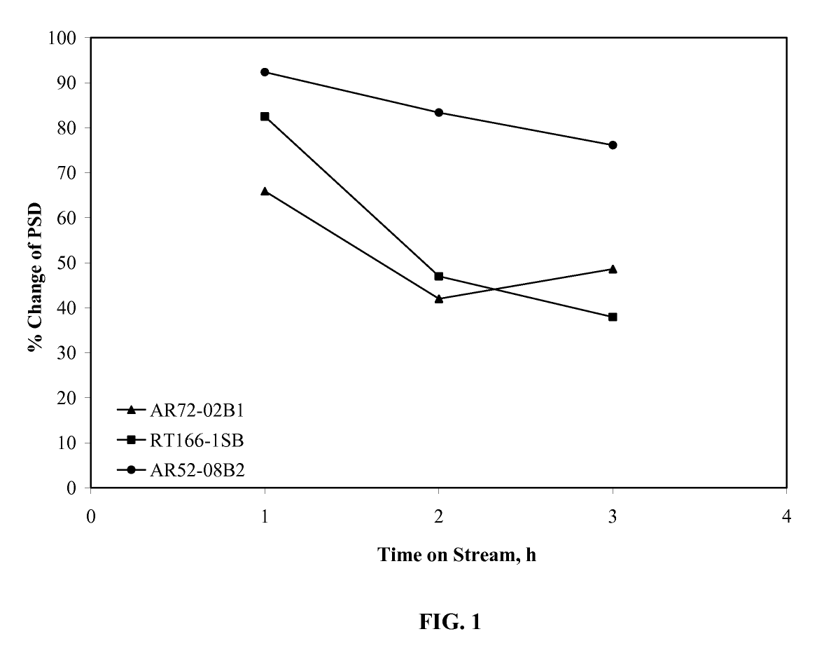

A number of materials have been activated with 100% CO in activation reactors at 275° C. for 24 hrs. Sample RT166-1SB, 100Fe/4Cu/3K/5SiO₂ (Ludox) was prepared using a co-feed precipitation method, and AR72-02B1 was prepared with 90/10 Fe(III)/Fe(II) and a composition of 100Fe/4Cu/3K/5SiO₂ (Ludox) have been evaluated. Data from these samples along with a representative AR52 sample can be seen in FIG. 1, which is a plot of percent change of particle size distribution (PSD) as a function of time following 24 h activation in 100% CO. From the data it can be seen that the RT166-1SB and AR72-02B1 are very similar in their chemical attrition, and appear more attrition resistant than the AR52 material.

### Example 4

### Air-Jet Attrition Tests

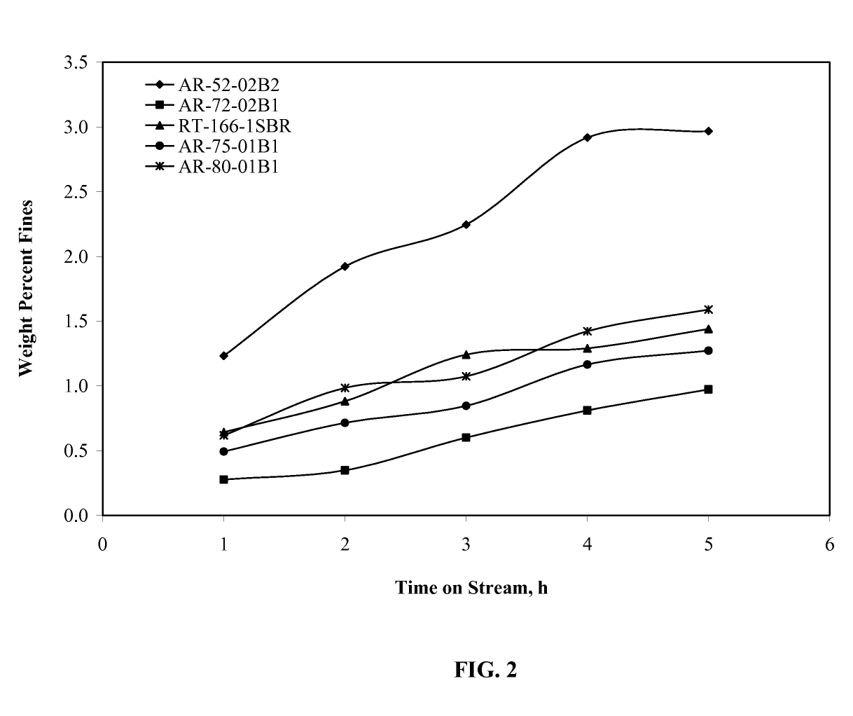

A number of samples have been evaluated by air-jet attrition testing. FIG. 2 is a plot of weight percent fines as a function of time on stream for catalysts RT166-1SB compared with AR75-01B1, AR80-01B, AR52-02B1 and AR72-02B1. Catalyst RT166-1SB was prepared using a co-feed precipitation method, and was calcined at 300° C. for 16 hours at 300° C./minute. Catalyst AR75-01B1 was prepared using polysilicic acid as the silica source with a composition of 100Fe/1.5Cu/1.5K/1.5SiO₂, the method comprising 35° C. and NH OH to acid. Catalyst AR80-01B1 was prepared with polysilicic acid as the silica source, iron as a 90/10 Fe(III)/Fe(II) nitrate solution and 35° C. and NH₄OH to 90/10 and had a catalyst composition of 100Fe/2Cu/2K/1.5SiO₂. The catalysts AR75-01B1 and AR80-01B1 were calcined at 300° C., 4 hours, 1° C./minute ramp.

TABLE 2
Co-Feed experiments.

| | | | | | | | | |
|---|---|---|---|---|---|---|---|---|
| | | Precip. | Hem. Peak | Cryst. | Surface | Pore Vol., | Pore | Mag. Susc,, |
| Cat # | Method | pH | (XRD) | Size, nm | Area, m²/g | cc/g | Dia., Å | 10⁶ Xg |

Catalysts Calcined at 380° C.

| | | | | | | | | |
|---|---|---|---|---|---|---|---|---|
| RT159-01A | Fe(III) + NH4OH → Fe(II) | 7.1 | 564 | 22 | 73.6 | 0.3421 | 97 | ≧3434 |
| RT162-1SA | Fe(III) + NH4OH → Fe(II) | 7.1 | 307 | — | 129.7 | 0.4690 | 78^{†} | 1580 |
| (Si) | | | | | | | | |
| RT166-1SA | Fe(III) + NH4OH → Fe(II) | 7.1 | 203 | — | 121.0 | 0.4895 | 78^{†} | — |
| (Si)* | | | | | | | | |
| RT169-1SA | Fe(III) + NH4OH → Fe(II) | 5.0 | 203 | — | 124.0 | 0.3768 | 60^{†} | — |
| (Si after ppt) | | | | | | | | |
| RT170-1SA | Fe(III) + NH4OH → Fe(II) | 7.2 | 194 | — | 131.5 | .5341 | 96^{†} | — |
| (Si after ppt) | | | | | | | | |
| RT168-01SA | Fe(II) + NH4OH → Fe(III) | 7.1 | 354 | 24 | 96.6 | 0.2166 | 57 | — |
| (Si)* | | | | | | | | |

Catalysts Calcined at 300° C.

| | | | | | | | | |
|---|---|---|---|---|---|---|---|---|
| RT159-01B | Fe(III) + NH4OH → Fe(II) | 7.1 | 298 | — | 107.0 | 0.3696 | 97 | ≧3822 |
| RT162-1SB | Fe(III) + NH4OH → Fe(II) | 7.1 | 275 | — | 147.5 | 0.4738 | 80^{†} | — |
| (Si) | | | | | | | | |
| RT166-1SB | Fe(III) + NH4OH → Fe(II) | 7.1 | 174 | — | 139.0 | 0.5422 | 78^{†} | — |
| (Si)* | | | | | | | | |
| RT169-1SB (Si | Fe(III) + NH4OH → Fe(II) | 5.0 | 189 | — | 140.8 | 0.3969 | 60^{†} | 3828 |
| after ppt) | | | | | | | | |
| RT170-1SB (Si | Fe(III) + NH4OH → Fe(II) | 7.2 | 178 | — | 144.3 | 0.5379 | 80^{†} | 2613 |
| after ppt) | | | | | | | | |
| RT168-01SB | Fe(II) + NH4OH → Fe(III) | 7.1 | 183 | — | 138.7 | 0.2326 | 44 | 664 |
| (Si)* | | | | | | | | |

*Quadruple batch, spray dried at Rentech.
^{†}Indicates the pore diameter peak was very broad.

Catalyst AR52-02B1, shown for comparison, had the composition 100Fe/3.0K/4.0Cu/5.0SiO₂. The silica source was 30% LUDOX. AR52-02B1 was formed by combining Fe° and Cu° powder with water, stirring; placing the Fe/Cu/H₂O in an ice bath and the monitoring the temperature. A 69% nitric acid solution was added drop-wise over about an hour keeping the temperature below 34° C. The mixture was heated to 70° C. and maintained at this temperature for 40 minutes. A quantity of ammonium hydroxide (29%) was diluted with deionized water. Ammonium hydroxide solution was added drop-wise and the pH reached about 7.15. A quantity of K₂CO₃ in deionized water was added and the mixture was stirred for another time. An amount of LUDOX AS-30 (ammonia stabilized colloidal silica, 30 wt % suspension in water, Sigma-Aldrich, Lot #16218BD) in deionized water was then added and the mixture was stirred. The mixture was spray dried in a bench-scale Niro instrument and the coarse and fine samples were collected. The coarse sample was calcined by heating at 30° C./min to 380° C., holding for 4 hours, and then cooling to room temperature.

Catalyst AR72-02B1 was formed with a nitrate solution comprising a 90/10 ratio of Fe(II)/Fe(III). From FIG. 2 it can be seen that RT166-1SB, AR75-01B1, AR80-01B1, and AR72-02B1 are significantly more attrition resistant than AR52-02B1. Using polysilicic acid as the silica source seems to produce a stronger catalyst with less silica.

### Example 5

### FTS Activity Studies

Four FT synthesis experiments were performed. For FTS activity studies, catalyst was evaluated by combining 310.0 g C-30 oil with 8 g of the catalyst, and loaded into a slurry bubble column reactor, SBCR.

For these experiments, catalyst activation was performed in H₂:CO of 0.7 or CO at 270° C. and 30 psig with a SV of 3.67 nl/h/g Fe, for 24 hours. The reaction was carried out at 245° C., 375 psig reaction pressure, (2.027 slph N₂, 10.307 slph CO, 7.936 slph H₂), a space velocity, SV, of 3.54 nl/h/g Fe, and a H₂:CO of 0.77.

Unless otherwise mentioned, the run was performed with a small CSTR. Alpha is the “Paraffin alpha α” is the calculated Anderson-Schulz-Flory (ASF) chain growth probability of hydrocarbons. “Single α” refers to a pseudo-alpha chain growth parameter predicted based on calculations. Using GCMS data, single alpha was predicted using the average with the light products (hydrogen, methane, CO, and CO₂) included. Although the single chain-growth parameter may not give a good representation of the carbon number distribution for an FT reaction, the α values determined by this method can be used to compare wax-producing tendencies of a catalyst at changing operating conditions and for comparing catalysts under the same operating conditions. The single chain-growth parameter α may thus be used as a quick screening estimation.

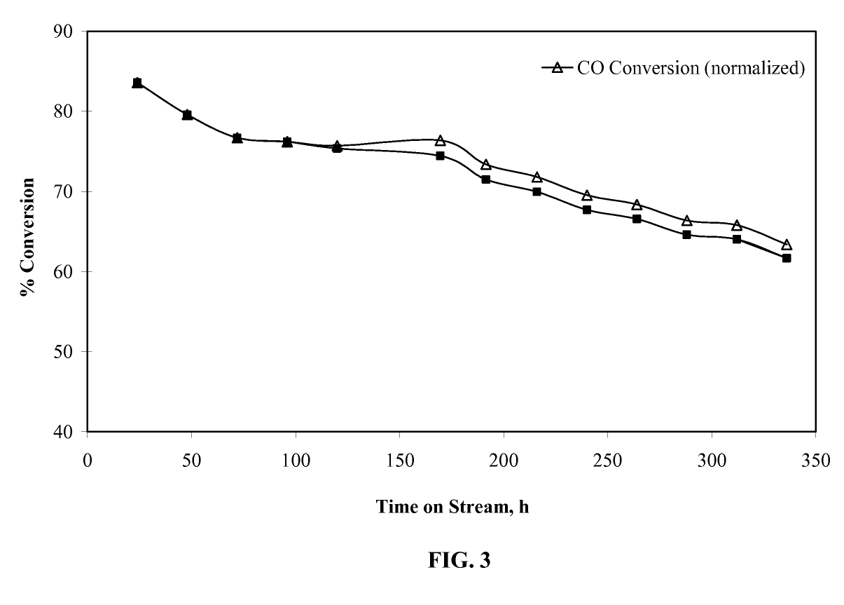

Catalyst, RT166-1SB, prepared using the co-feed precipitation method according to embodiment 2 presented in section II hereinabove, whereby Fe(III) and NH₄OH were added to a dilute Fe(II) solution with a 90/10 Fe(III)/Fe(II) ratio. This catalyst was evaluated by combining 310.0 g C-30 oil with 8 g of RT-166 co-feed catalyst, BAO-311. Data for this experiment is shown in FIG. 3, which shows percent conversion (based on nitrogen balance) as a function of time on stream. This catalyst is very interesting because of the large pore volume and large pore size distribution, as shown in Tables 1 and 2. This catalyst has significant activity >80% at 245° C. reaction temperature, but also deactivates at a very high rate.

Catalyst RT166-1SB was also evaluated for 230 hours with constant CO conversion of about 60%. The activation for this run was CO at 230° C., 140 psig for 24 hours. Though the conversion was significantly less the deactivation was much less as well. Activation conditions play a role with respect to activity and deactivation of iron catalyst.

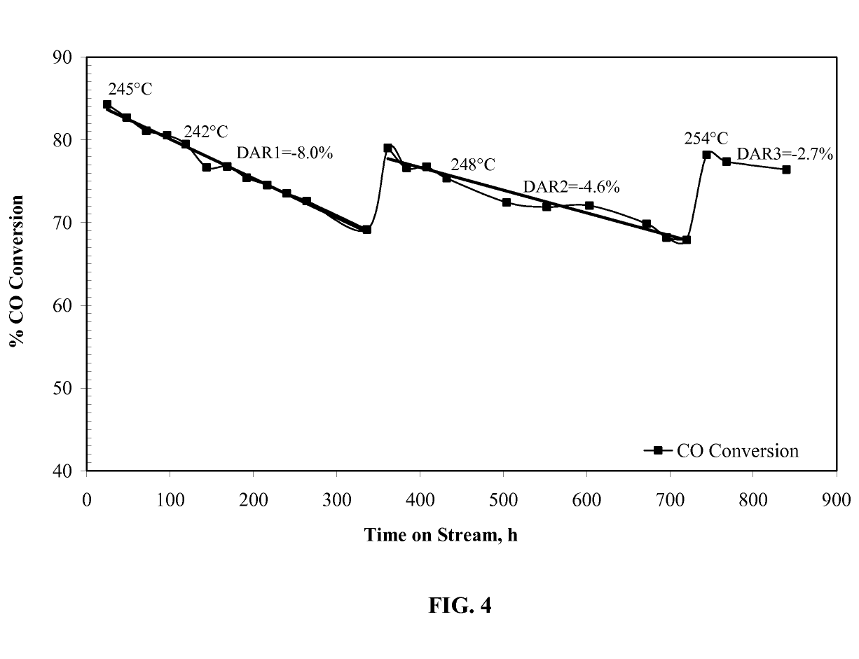

For comparison, with co-feed catalyst RT-1661SB, two runs were made with the catalyst AR52. FIG. 4 shows percent conversion (based on nitrogen balance) as a function of time on stream. As mentioned above, comparison catalyst AR52 comprises had the composition 100Fe/3.0K/4.0Cu/5.0SiO₂ and was not formed utilizing the co-feed method. Run BAO-306, shown in FIG. 4, AR52-09B1 was activated with Syngas, H₂/CO=0.7, 270° C., 30 psig, for 24 hours. Though there is initial high activity at relatively low reaction temperatures, <250° C., the deactivation rate is quite high (DAR=−8.0%). However, after 340 hr, the temperature was raised from 242° C. to 248° C. and 10% more CO conversion resulted with an apparent lower DAR, only −4.5%. After 670 hours on stream the catalysts still has 70% CO conversion.

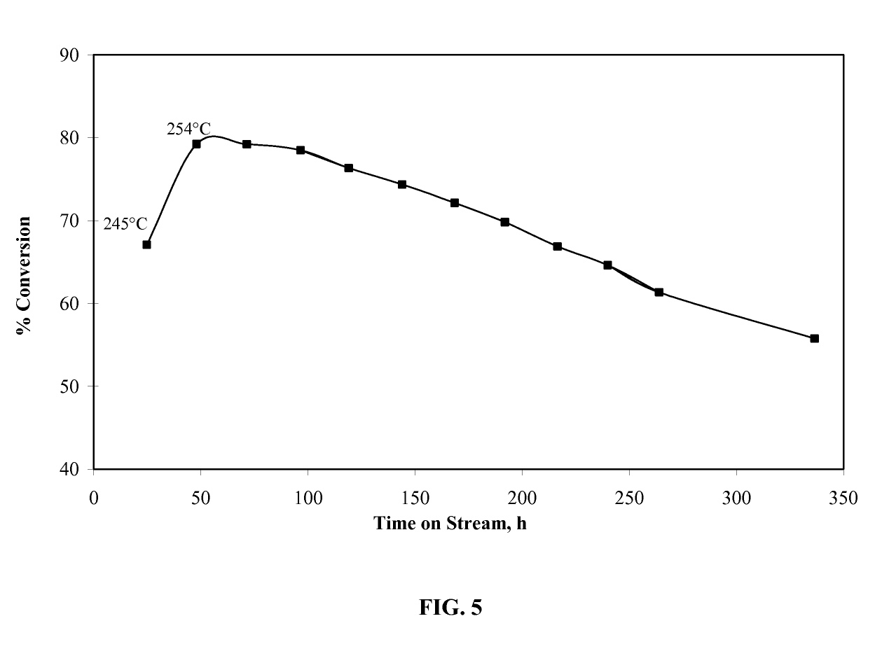

The same catalyst, AR52-09B1 was activated with CO at 270° C. at 30 psig for 24 hours. Data for this run, BAO-307 can be seen in FIG. 5, which shows percent conversion (based on nitrogen balance) as a function of time on stream. In this run, catalyst AR52 was not as active at lower temperatures and the deactivation rate was high and rapid. Theses experiments indicate that activation of the catalyst is very important for both activity and deactivation.

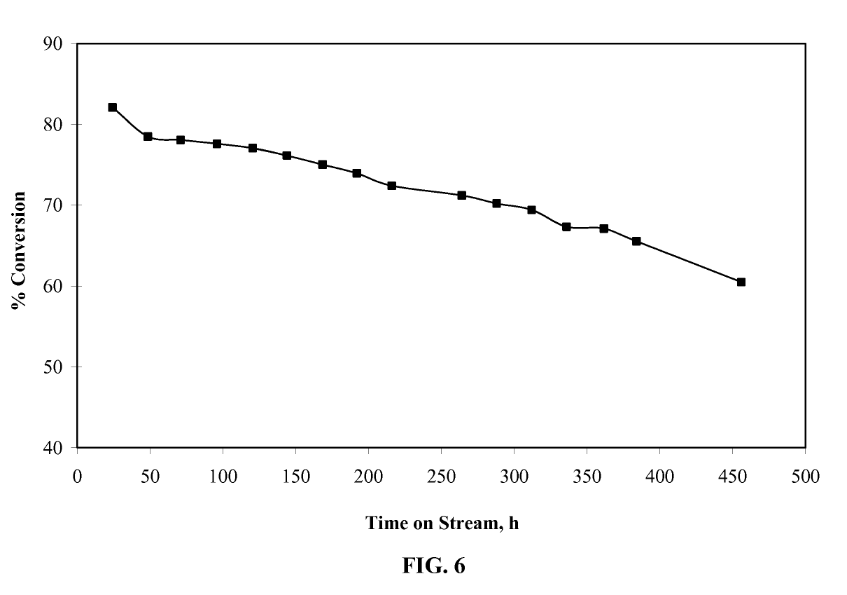

A variation of catalyst AR52, AR72-01B1, was prepared using a 90/10 Fe(III)/Fe(II) ratio. This material was evaluated for activity, BAO-308, using the same CO activation as BAO-307. Data for this experiment can be seen in FIG. 6, which shows percent conversion (based on nitrogen balance) as a function of time on stream. Comparison with BAO-307 show a higher CO conversion at a lower reaction temperature and lower deactivation rate. Syngas activation conditions of BAO-306 may help to further reduce the deactivation rate and keep the CO conversion high at lower temperatures for this 90/10 catalyst.

From the results presented in FIGS. 3-6, it appears that co-feed catalyst RT166-1SB exhibited comparable chain growth (measured by alpha which is indicative of the average molecular weight of the liquid products produced) and a somewhat lower CO conversion compared with the catalysts AR52 and 90/10 non-co-feed catalyst AR72-01B1.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. Accordingly, the scope of protection is not limited to the embodiments described herein, but is only limited by the claims which follow, the scope of which shall include all equivalents of the subject matter of the claims.

What is claimed is:

1. A method of producing a catalyst precursor comprising iron phases, the method comprising:
(a) co-feeding a ferrous nitrate solution and a precipitation agent into a ferric nitrate solution to produce a precipitation solution from which catalyst precursor precipitates, wherein the ratio of ferrous nitrate solution to ferric nitrate solution in the precipitation solution is a desired ratio;
(b) co-feeding a ferric nitrate solution and a precipitation agent into a ferrous nitrate solution to produce a precipitation solution from which catalyst precursor precipitates, wherein the ratio of ferrous nitrate solution to ferric nitrate solution in the precipitation solution is a desired ratio; or
(c) precipitating a ferrous precipitate from a ferrous nitrate solution by contacting the ferrous nitrate solution with a first precipitation agent; precipitating a ferric precipitate from ferric nitrate solution by contacting the ferric nitrate solution with a second precipitation agent; and combining the ferrous precipitate and the ferric precipitate to form the catalyst precursor, wherein the ratio of ferrous precipitate to ferric precipitate is a desired ratio;
wherein the iron phases are chosen from iron carbonates, iron oxides, iron hydroxides or combinations thereof.

2. The method of claim 1 wherein the precipitation agent is selected from the group consisting of NH₄OH, (NH₄)₂CO₃, NH₄HCO₃, NaOH, Na₂CO₃, NaHCO₃, KOH, K₂CO₃, KHCO₃, and combinations thereof.

3. The method of claim 2 wherein the precipitation agent comprises sodium carbonate.

4. The method of claim 2 wherein the precipitation agent comprises ammonium hydroxide.

5. The method of claim 1 wherein the first precipitation agent and the second precipitation agent are the same.

6. The method of claim 1 wherein the ratio of ferrous nitrate solution to ferric nitrate solution is in the range of from about 1:2.3 to about 1:10.

7. The method of claim 6 wherein the ratio of ferrous nitrate solution to ferric nitrate solution is about 1:3.

8. The method of claim 6 wherein the ratio of ferrous nitrate solution to ferric nitrate solution is about 1:9.

10. The method of claim 1 further comprising co-precipitating at least one other metal or metalloid from a nitrate solution.

11. The method of claim 10 wherein the at least one other metal or metalloid is selected from the group consisting of magnesium, copper, aluminum, silicon, and combinations thereof.

12. The method of claim 1 wherein the ferrous nitrate solution, the ferric nitrate solution, the precipitation solution, or a combination thereof comprises at least one other metal or metalloid.

13. The method of claim 1 wherein (c) further comprises precipitating at least one other precipitate from an additional nitrate solution with a precipitation agent, and wherein combining the ferrous precipitate and the ferric precipitate to form the catalyst precursor further comprises combining the at least one other precipitate with the ferrous precipitate and the ferric precipitate.

14. The method of claim 13 wherein the additional nitrate solution comprises a metal or metalloid selected from the group consisting of aluminum, silicon, magnesium, copper, and combinations thereof.

15. The method of claim 14 wherein the additional nitrate solution comprises copper.

16. A catalyst precursor according to claim 1.

17. A method of producing a catalyst, the method comprising:
obtaining a catalyst precursor according to claim 1;
washing the catalyst precursor; and
alkalizing the washed catalyst precursor with an alkaline material.

18. The method of claim 17 wherein the alkaline material comprises potassium carbonate.

19. The method of claim 17 wherein the desired ratio of ferrous nitrate solution to ferric nitrate solution is in the range of from about 1:2.3 to about 1:10.

20. The method of claim 19 wherein the ratio of ferrous nitrate solution to ferric nitrate solution is about 1:3.

21. The method of claim 19 wherein the ratio of ferrous nitrate solution to ferric nitrate solution is about 1:9.

22. The method of claim 17 further comprising co-precipitating at least one other metal or metalloid from a nitrate solution.

23. The method of claim 22 wherein the at least one other metal or metalloid is selected from the group consisting of magnesium, copper, aluminum, silicon, and combinations thereof.

24. The method of claim 22 wherein the ferrous nitrate solution, the ferric nitrate solution, the precipitation solution, or a combination thereof comprises at least one other metal or metalloid.

25. The method of claim 17 wherein (c) further comprises precipitating at least one other precipitate from an additional nitrate solution with a precipitation agent, and wherein combining the ferrous precipitate and the ferric precipitate to form the catalyst precursor further comprises combining the at least one other precipitate with the ferrous precipitate and the ferric precipitate.

26. The method of claim 25 wherein the additional nitrate solution comprises a metal or metalloid selected from the group consisting of aluminum, silicon, magnesium, copper, and combinations thereof.

27. The method of claim 17 further comprising contacting the washed catalyst precursor with a structural promoter to produce a promoted the catalyst.

28. A catalyst according to claim 17.

29. The catalyst of claim 28 wherein the desired ratio of ferrous nitrate solution to ferric nitrate solution is in the range of from about 1:2.3 to about of about 1:10.

30. The method of claim 29 wherein the ratio of ferrous nitrate solution to ferric nitrate solution is about 1:3.
